(19) United States
(12) Patent Application Publication
(10) Pub. No.: US 2025/0135960 A1
(43) Pub. Date: May 1, 2025

(54) CONTROL SYSTEM, WORK VEHICLE, AND WORK VEHICLE CONTROL METHOD

(71) Applicant: Komatsu Ltd., Tokyo (JP)

(72) Inventor: Shota Yamawaki, Tokyo (JP)

(73) Assignee: Komatsu Ltd., Tokyo (JP)

(21) Appl. No.: 18/728,479

(22) PCT Filed: Jan. 24, 2023
(86) PCT No.: PCT/JP2023/002049

§ 371 Date: Jul. 12, 2024

(30) Foreign Application Priority Data
Jan. 31, 2022 (JP) 2022-012530

(51) Int. Cl. B60L 58/40; B60L 58/13

(52) U.S. Cl. CPC B60L 58/40; B60L 58/13; B60L 2200/40; B60L 2240/622; B60L 2260/54

(57) ABSTRACT

A power determination unit determines a target power generation amount of a fuel cell, based on a time series of measurement values relating to power while a work vehicle travels along a predetermined travel route. A fuel cell control unit controls the fuel cell to output the target power generation amount while the work vehicle travels along the travel route. A battery control unit controls charging or discharging of a battery, based on a difference between required power required for driving the work vehicle and the target power generation amount while the work vehicle travels along the travel route.

### TECHNICAL FIELD

The present disclosure relates to a control system, a work vehicle, and a control method for a work vehicle.

Priority is claimed on Japanese Patent Application No. 2022-012530, filed Jan. 31, 2022, the content of which is incorporated herein by reference.

### BACKGROUND ART

Patent Document 1 discloses an energy management technology in which a power amount consumed for an operation in one cycle is monitored to limit power supplied to a motor such that the number of operations of remaining work can be performed in accordance with a current state of charge (SOC) of a battery. However, in recent years, a work vehicle equipped with a fuel cell that uses a hydrogen gas as a fuel has been studied. The work vehicle driven by the fuel cell generally includes the battery in order to suppress a mounted amount of the fuel cell and to absorb regenerative power when the work vehicle travels downhill.

### CITATION LIST

### Patent Document

[Patent Document 1]

Japanese Unexamined Patent Application, First Publication No. 2012-250841

### SUMMARY OF INVENTION

### Technical Problem

A range extender method is known as a method for activating a power supply system including the fuel cell and the battery. The range extender method is a method in which constant power is output from the fuel cell at all times and a difference between power required for driving the work vehicle and power output by the fuel cell is covered by charging or discharging of the battery. However, a travel route of a mine is not necessarily constant, and a load applied to travelling along a travel route fluctuates. Even in this occasion, it is desirable to appropriately acquire the power output by the fuel cell.

An object of the present disclosure is to provide a control system, a work vehicle, and a control method for a work vehicle, which can appropriately distribute energy of a fuel cell and a battery.

### Solution to Problem

According to an aspect of the present disclosure, there is provided a control system configured to control a work vehicle including a fuel cell and a battery. The control system includes a power determination unit configured to determine a target power generation amount of the fuel cell, based on a time series of measurement values relating to power while the work vehicle travels along a predetermined travel route, a fuel cell control unit configured to control the fuel cell to output the target power generation amount while the work vehicle travels along the travel route, and a battery control unit configured to control charging or discharging of the battery, based on a difference between required power required for driving the work vehicle and the target power generation amount while the work vehicle travels along the travel route.

### Advantageous Effects of Invention

According to the above-described aspect, the control system can appropriately distribute energy of the fuel cell and the battery.

### BRIEF DESCRIPTION OF DRAWINGS

FIG. 1 is a diagram representing a configuration of a transport system according to a first embodiment.

FIG. 2 is a perspective view schematically representing a transport vehicle according to the first embodiment.

FIG. 3 is a schematic block diagram representing configurations of a power system and a drive system which are included in the transport vehicle according to the first embodiment.

FIG. 4 is a schematic block diagram representing a configuration of a control system included in the transport vehicle according to the first embodiment.

FIG. 5 is a flowchart representing a process in which control data is set by a control device according to the first embodiment.

FIG. 6 is a flowchart representing a process in which travel control is performed by the control device according to the first embodiment.

FIG. 7 is a flowchart representing a process in which control data is set by a control device according to a second embodiment.

FIG. 8 is a schematic block diagram representing a configuration of a computer according to at least one embodiment.

### DESCRIPTION IN EMBODIMENTS

### First Embodiment

### <<Configuration of Transport System 1>>

Hereinafter, an embodiment will be described in detail with reference to the drawings.

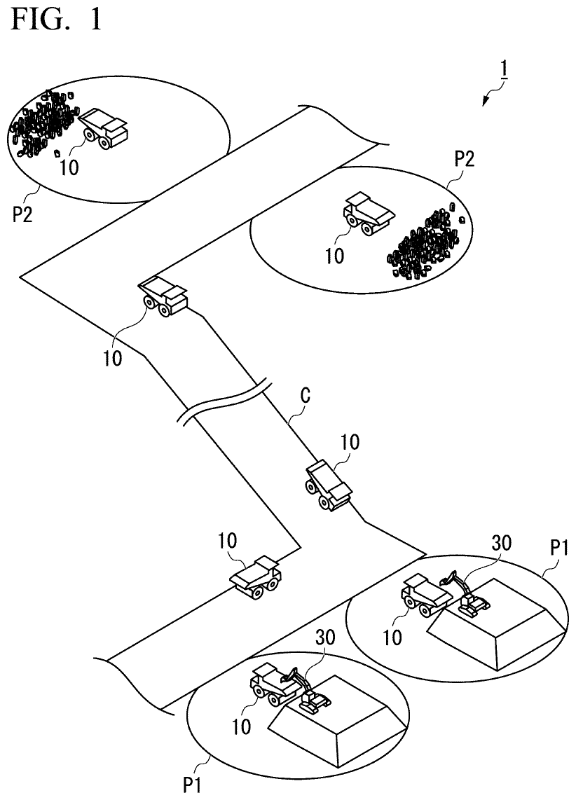

FIG. 1 is a diagram representing a configuration of a transport system 1 according to a first embodiment. The transport system 1 is used to transport mined crushed stones and the like, by using a plurality of transport vehicles 10. The transport vehicle 10 is driven by a fuel cell which uses a hydrogen gas as a fuel. The transport vehicle 10 is an example of a work vehicle.

In a mine, a mining field P1 and an earth disposal field P2 are provided. The crushed stones are loaded into the transport vehicle 10 by a loading machine 30 in the mining field P1. The transport vehicle 10 transports the crushed stones to the earth disposal field P2, and discharges the crushed stones in the earth disposal field P2. For example, the loading machine 30 may be a hydraulic excavator or a wheel loader.

When the crushed stone is discharged in the earth disposal field P2, the transport vehicle 10 moves to the mining field P1 again, and loads collected stones. In the mine, a course C along which the transport vehicle 10 travels is provided. The course C may be a road for two-way traffic as represented in FIG. 1, or may be a one-way road. The transport vehicle 10 travels along a travel route along which the transport vehicle 10 returns to the mining field P1 from the mining field P1 via the earth disposal field P2. The travel route of the transport vehicle 10 may be determined in advance, or may be dynamically assigned by a management device (not represented). When the travel route is dynamically assigned, the mining field P1 of the start point and the mining field P1 of the end point in the travel route may be the same as each other, or may be different from each other.

### <<Configuration of Transport Vehicle 10>>

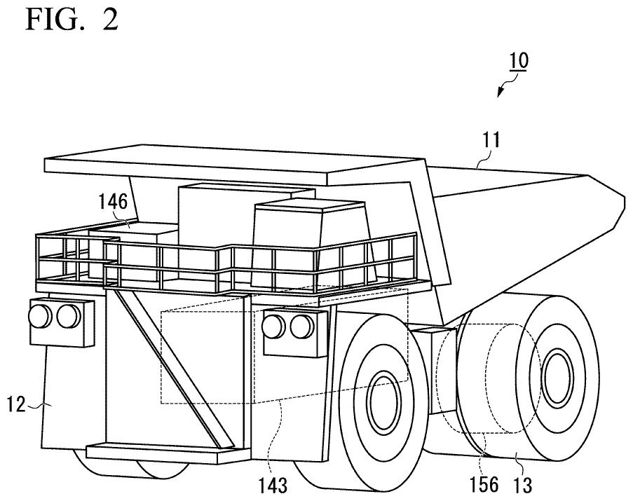

FIG. 2 is a perspective view schematically representing the transport vehicle 10 according to the first embodiment. The transport vehicle 10 includes a dump body 11, a vehicle body 12, and a travel device 13.

The dump body 11 is a member into which a cargo is loaded. At least part of the dump body 11 is disposed above the vehicle body 12. The dump body 11 performs a dumping operation and a lowering operation. Through the dumping operation and the lowering operation, the dump body 11 is adjusted to have a dumping posture and a loading posture. The dumping posture refers to a posture in which the dump body 11 is raised. The loading posture refers to a posture in which the dump body 11 is lowered.

The dumping operation refers to an operation of separating the dump body 11 from the vehicle body 12 and inclining the dump body 11 in a dumping direction. The dumping direction is a rearward direction of the vehicle body 12. In the embodiment, the dumping operation includes raising a front end part of the dump body 11 and inclining the dump body 11 rearward. Through the dumping operation, a loading surface of the dump body 11 is inclined rearward and downward.

The lowering operation refers to an operation of bringing the dump body 11 closer to the vehicle body 12. In the embodiment, the lowering operation includes lowering a front end part of the dump body 11.

When dumping work is carried out, the dump body 11 performs the dumping operation to change the loading posture to the dumping posture. When the cargo is loaded into the dump body 11, the cargo is discharged rearward from a rear end part of the dump body 11 through the dumping operation. When loading work is carried out, the dump body 11 is adjusted to the loading posture.

The vehicle body 12 includes a vehicle body frame. The vehicle body 12 supports the dump body 11. The vehicle body 12 is supported by the travel device 13.

The travel device 13 supports the vehicle body 12. The travel device 13 causes the transport vehicle 10 to travel. The travel device 13 causes the transport vehicle 10 to advance or retreat. At least part of the travel device 13 is disposed below the vehicle body 12. The travel device 13 includes a pair of front wheels and a pair of rear wheels. The front wheels are steering wheels, and the rear wheels are driving wheels. A combination of the steering wheels and the driving wheels is not limited thereto, and the travel device 13 may adopt four-wheel driving or four-wheel steering.

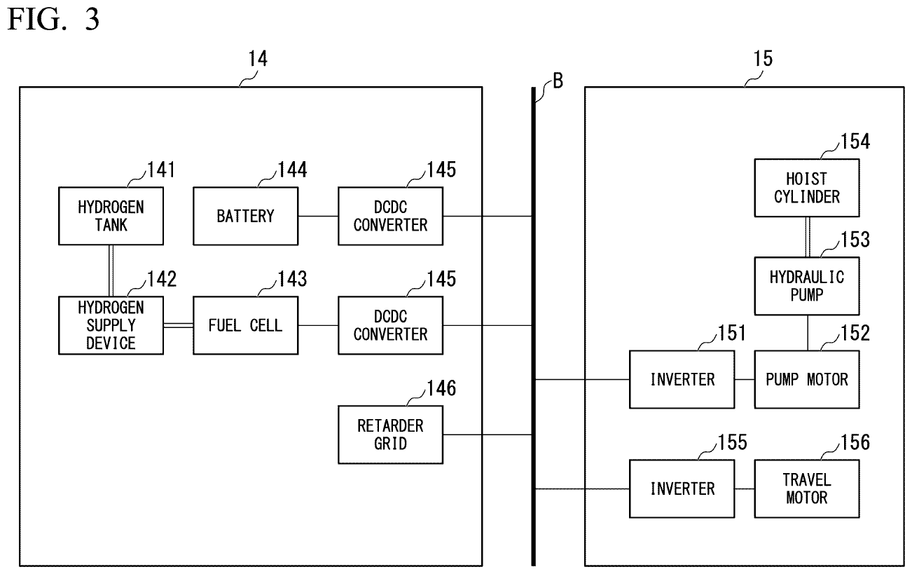

FIG. 3 is a schematic block diagram representing a configuration of a power system 14 and a drive system 15 which are included in the transport vehicle 10 according to the first embodiment. The power system 14 includes a hydrogen tank 141, a hydrogen supply device 142, a fuel cell 143, a battery 144, a DCDC converter 145, and a retarder grid 146.

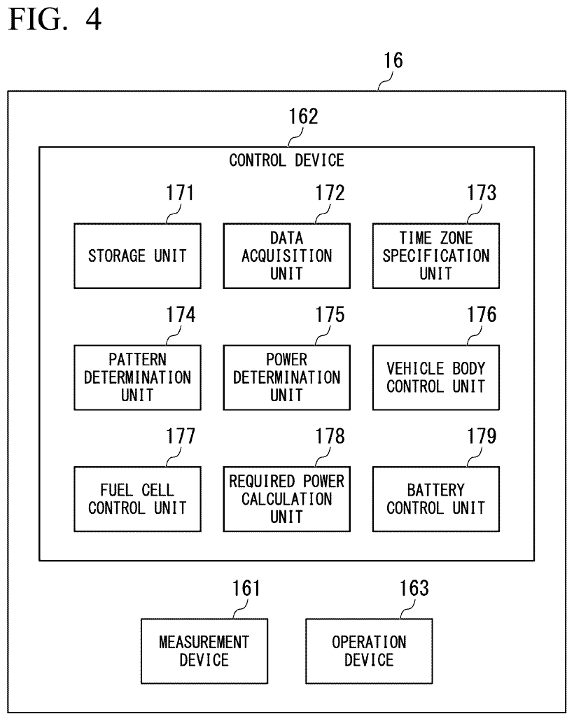

The hydrogen supply device 142 supplies a hydrogen gas filling the hydrogen tank 141 to the fuel cell 143. The fuel cell 143 generates power by causing an electrochemical reaction between hydrogen supplied from the hydrogen supply device 142 and oxygen included in outside air. The battery 144 stores the power generated by the fuel cell 143. The DCDC converter 145 outputs the power from the connected fuel cells 143 or the connected battery 144 in accordance with an instruction from a control system 16 (refer to FIG. 4). The retarder grid 146 converts regenerative power from the drive system 15 into heat energy when the battery 144 cannot be charged.

The power output from the power system 14 is output to the drive system 15 via a bus B. The drive system 15 includes an inverter 151, a pump drive motor 152, a hydraulic pump 153, a hoist cylinder 154, an inverter 155, and a travel drive motor 156. The inverter 151 converts a direct current from the bus B into a three-phase alternating current, and supplies the three-phase alternating current to the pump drive motor 152. The pump drive motor 152 drives the hydraulic pump 153. A hydraulic oil discharged from the hydraulic pump 153 is supplied to the hoist cylinder 154 via a control valve (not represented). Since the hydraulic oil is supplied to the hoist cylinder 154, the hoist cylinder 154 is operated. The hoist cylinder 154 causes the dump body 11 to perform the dumping operation or the lowering operation. The inverter 155 converts the direct current from the bus B into the three-phase alternating current, and supplies the three-phase alternating current to the travel drive motor 156. A rotational force generated by the travel drive motor 156 is transmitted to the driving wheels of the travel device 13.

The transport vehicle 10 includes the control system 16 configured to control the power system 14 and the drive system 15. FIG. 4 is a schematic block diagram representing a configuration of the control system 16 included in the transport vehicle 10 according to the first embodiment. The control system 16 includes a measurement device 161, a control device 162, and an operation device 163.

The measurement device 161 collects data relating to an activation state and a travel state of the transport vehicle 10. The measurement device 161 includes at least a positioning device that measures a position and an azimuth direction of the transport vehicle 10 by using a global navigation satellite system (GNSS), a speedometer that measures a speed of the transport vehicle 10, and a power meter that measures a magnitude of power supplied to the battery 144 and power discharged from the battery 144.

The control device 162 drives the transport vehicle 10 in accordance with measurement data acquired by the measurement device 161 and an operation amount of the operation device 163.

The operation device 163 is provided in a cab, and receives an operation performed by an operator. The operation device 163 includes an accelerator pedal, a brake pedal, a steering wheel, and a dump lever, and the like.

The control device 162 includes a storage unit 171, a data acquisition unit 172, a time zone specification unit 173, a pattern determination unit 174, a power determination unit 175, a vehicle body control unit 176, a fuel cell control unit 177, a required power calculation unit 178, and a battery control unit 179.

The data acquisition unit 172 acquires measurement data from the measurement device 161. The data acquisition unit 172 records the acquired measurement data in the storage unit 171 together with time information.

The time zone specification unit 173 specifies a time zone in which the transport vehicle 10 travels along the travel route by specifying a timing at which the transport vehicle 10 is present in the mining field P1, based on the measurement data of the position of the transport vehicle 10 which is acquired by the measurement device 161. That is, the time zone specification unit 173 specifies a timing at which the transport vehicle 10 is present in the mining field P1 at the start point of the travel route and a timing at which the transport vehicle 10 is present in the mining field P1 at the end point of the travel route. The time zone specification unit 173 can determine that the transport vehicle 10 is present in the earth disposal field P2 when the dump lever is operated by the operation device 163. Therefore, in another embodiment in which the travel route is a route in which the transport vehicle 10 returns to the earth disposal field P2 from the earth disposal field P2 via the mining field P1, the time zone specification unit 173 may specify the time zone in which the transport vehicle 10 travels along the travel route, based on the operation of the dump lever by the operation device 163. In other words, the time zone specification unit 173 specifies each timing at which the transport vehicle 10 is located at the specification point, and specifies a time zone between two consecutive timings in a plurality of specified timings, as a time zone in which the transport vehicle 10 travels along the travel route. The mining field P1 according to the first embodiment is an example of the specification point. In addition, in another embodiment in which the travel route is a route in which the transport vehicle 10 returns to the earth disposal field P2 from the earth disposal field P2 via the mining field P1, the earth disposal field P2 is an example of the specification point.

The transport vehicle 10 remains in the mining field P1 such that the crushed stones are loaded by the loading machine 30 in the mining field P1. In order to specify one timing in a period during which the transport vehicle 10 is present in the mining field P1, for example, the time zone specification unit 173 may specify a timing at which the position of the transport vehicle 10 indicated by the measurement data is changed from the outside of the mining field P1 to the inside of the mining field P1, or may specify a timing at which the transport vehicle 10 is located in the mining field P1 and is changed from a travel state to a stopped state.

The pattern determination unit 174 determines whether or not the transport vehicle 10 travels along the travel route in a normal pattern in the time zone specified by the time zone specification unit 173. Examples of cases where the transport vehicle 10 does not travel along the travel route in the normal pattern include a case where the transport vehicle 10 travels out of the travel route to supply the hydrogen gas (case where the transport vehicle 10 does not travel along the travel route) and a case where the transport vehicle 10 is stopped for a long time such that a worker takes a break (case where the transport vehicle 10 does not travel along the travel route in the normal pattern). The pattern determination unit 174 determines whether or not a length of the time zone specified this time corresponds to an outlier, based on an average value and a standard deviation of the lengths of the plurality of time zones specified in the past by the time zone specification unit 173. In this manner, the pattern determination unit 174 determines whether or not the transport vehicle 10 travels along the travel route in the normal pattern. In another embodiment, it may be determined whether or not the transport vehicle 10 travels along the travel route in the normal pattern, based on similarity between a feature amount of a time series of the measurement data relating to the plurality of time zones specified in the past by the time zone specification unit 173 and a feature amount of a time series of the measurement data in the time zone specified this time.

The power determination unit 175 calculates a charging amount and a discharging amount of the battery 144 in the time zone, from a time series of the measurement data in the time zone specified by the time zone specification unit 173. The time series of the measurement data is a data array in which the measurement data is arrayed in order of measurement times. The power determination unit 175 calculates a sum of power amounts charged for the battery 144 (for example, power amounts having a plus sign of the measurement data) and a sum of power amounts discharged from the battery 144 (for example, power amounts having a minus sign of the measurement data) in the time series of the measurement data. The power determination unit 175 determines the target power generation amount of the fuel cell 143, based on the charging amount and the discharging amount of the battery 144 in the specified time zone. The power determination unit 175 sets the determined target power generation amount in the fuel cell control unit 177. The power determination unit 175 according to the first embodiment sets a unique target power generation amount for each travel route. That is, the target power generation amount is a constant value while the transport vehicle 10 travels along the travel route.

The vehicle body control unit 176 generates a control signal for controlling the transport vehicle 10 in accordance with an operation amount of the operation device 163. For example, the vehicle body control unit 176 generates a control signal for controlling steering, accelerating, braking, or a dump body operation of the travel device 13 or the like.

The fuel cell control unit 177 controls a hydrogen supply amount of the hydrogen supply device 142 such that the fuel cell 143 outputs the target power generation amount set by the power determination unit 175. In the first embodiment, a constant value is set as the target power generation amount regardless of a time. Therefore, the fuel cell control unit 177 controls the hydrogen supply amount of the hydrogen supply device 142 such that constant power is output while the transport vehicle 10 travels along the travel route.

For example, the required power calculation unit 178 calculates required power required for the power system 14 with reference to a table stored in advance, based on the control signal generated by the vehicle body control unit 176.

The battery control unit 179 calculates a difference between the power generation amount of the fuel cell 143 and the required power. The battery control unit 179 controls the DCDC converter 145 connected to the battery 144 such that the power relating to the difference charges the battery 144 when the power generation amount is larger than the required power, and the power relating to the difference is discharged from the battery 144 when the power generation amount is smaller than the required power.

### <<Operation of Control Device 162>>

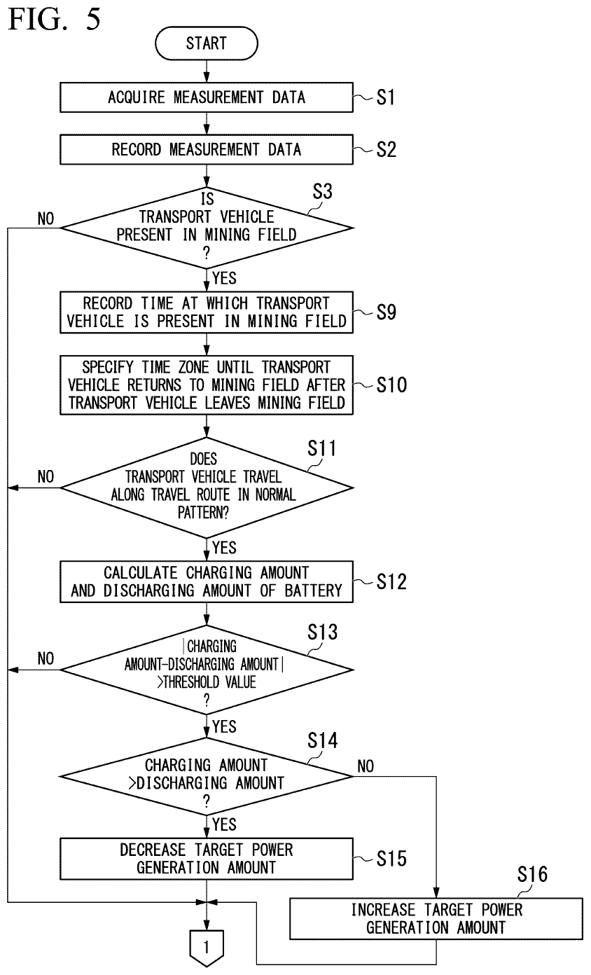

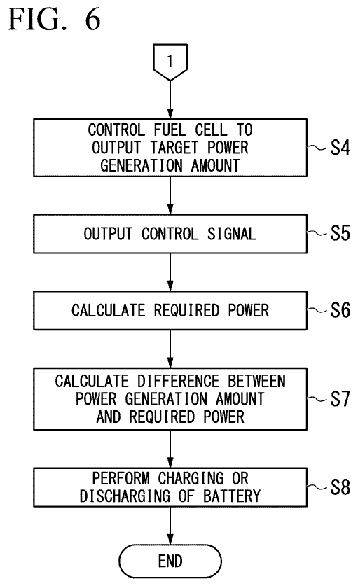

FIG. 5 is a flowchart representing a process in which control data is set by the control device 162 according to the first embodiment. FIG. 6 is a flowchart representing a process in which travel control is performed by the control device 162 according to the first embodiment. The control device 162 performs the following process for each predetermined control cycle.

The data acquisition unit 172 of the control device 162 acquires the measurement data from the measurement device 161 (Step S1). The data acquisition unit 172 records the acquired measurement data in the storage unit 171 together with time information (Step S2). Next, the time zone specification unit 173 determines whether or not the transport vehicle 10 is present in the mining field P1, based on the acquired measurement data (Step S3).

When it is determined that the transport vehicle 10 is not present in the mining field P1 (Step S3: NO), the fuel cell control unit 177 controls the hydrogen supply device 142 such that the fuel cell 143 outputs the target power generation amount set in advance or set by the power determination unit 175 (Step S4). The vehicle body control unit 176 generates a control signal for controlling the transport vehicle 10, based on an operation amount of the operation device 163, and outputs the control signal to each actuator (Step S5). The required power calculation unit 178 calculates the required power required for the power system 14, based on the control signal generated in Step S5 (Step S6). The battery control unit 179 calculates a difference between the power generation amount of the fuel cell 143 and the required power (Step S7). The battery control unit 179 controls the DCDC converter 145 connected to the battery 144 to realize charging or discharging of the battery 144, based on power relating to the difference (Step S8). The control device 162 returns to the process in Step S1, and determines to receive subsequent control data.

When it is determined that the transport vehicle 10 is present in the mining field P1 (Step S3: YES), the time zone specification unit 173 records a current time in the storage unit 171, as a time at which the transport vehicle 10 is present in the mining field P1 (Step S9). The time zone specification unit 173 specifies the time zone until the current time from the time at which the transport vehicle 10 is present in the mining field P1 (Step S10). The pattern determination unit 174 compares the time zone specified in Step S10 with the time zone measured in the past in which the transport vehicle 10 returns to the mining field P1 after leaving the mining field P1, and determines whether or not the transport vehicle 10 travels along the travel route in the normal pattern in the time zone specified in Step S10 (Step S11).

When the pattern determination unit 174 determines that the transport vehicle 10 does not travel along the travel route in the normal pattern in the time zone specified in Step S10 (Step S11: NO), the control device 162 controls the transport vehicle 10 by performing the processes from Step S4 to Step S8 without updating the target power generation amount.

When the pattern determination unit 174 determines that the transport vehicle 10 travels along the travel route in the normal pattern in the time zone specified in Step S10 (Step S11: YES), the power determination unit 175 calculates the charging amount and the discharging amount of the battery 144 in the time zone, based on the time series of the measurement data in the time zone specified in Step S10 (Step S12). The power determination unit 175 determines whether or not an absolute value of the difference between the charging amount and the discharging amount of the battery 144 exceeds a predetermined threshold value (Step S13).

When the absolute value of the difference between the charging amount and the discharging amount of the battery 144 does not exceed the threshold value (Step S13: NO), the control device 162 controls the transport vehicle 10 by performing the processes from Step S4 to Step S8 without updating the target power generation amount. The reason is that the charging/discharging amount of the battery 144 is balanced with a current set value.

On the other hand, when the absolute value of the difference between the charging amount and the discharging amount of the battery 144 exceeds the threshold value (Step S13: YES), the power determination unit 175 determines whether or not the charging amount is larger than the discharging amount (Step S14). When the charging amount is larger than the discharging amount (Step S14: YES), the power determination unit 175 decreases the target power generation amount by a unit amount from the current value (Step S15). On the other hand, when the discharging amount is larger than the charging amount (Step S14: NO), the power determination unit 175 increases the target power generation amount by a unit amount from the current value (Step S16). In another embodiment, the power determination unit 175 may increase or decrease the target power generation amount by the amount proportional to a magnitude of the absolute value of the difference between the charging amount and the discharging amount. The control device 162 controls the transport vehicle 10, based on the updated target power generation amount, by performing the processes from Step S4 to Step S8.

### <<Operational Effect>>

In this way, the transport system 1 according to the first embodiment determines the target power generation amount of the fuel cell 143, based on the time series of the measurement values relating to the power while the transport vehicle 10 travels along the travel route, and controls the fuel cell 143 in accordance with the determined target power generation amount. In this manner, the transport vehicle 10 determines the target power generation amount such that the battery 144 can absorb load fluctuations, based on a travel history of the travel route in the past. In this manner, the transport vehicle 10 can keep balance between the charging amount and the discharging amount of the battery 144 in the travel along the travel route. The measurement device 161 according to the first embodiment measures charging power and discharging power of the battery 144, but the present disclosure is not limited thereto. For example, the measurement device 161 according to another embodiment may monitor an SOC of the battery 144. In this case, the measurement device 161 may determine the target power generation amount, based on a difference between the SOC at the start point of the time zone and the SOC at the end point of the time zone. The SOC of the battery 144 is an example of a measurement value relating to the power.

In addition, the transport system 1 according to the first embodiment determines whether or not the transport vehicle 10 travels along the travel route in the normal pattern, by comparing a time zone in which there is a possibility that the transport vehicle 10 travels along the travel route with a time zone specified in the past. In this manner, it is possible to prevent the target power generation amount from being inappropriately updated, based on the measurement data when the transport vehicle 10 irregularly travels.

### Second Embodiment

The control device 162 according to the first embodiment updates the target power generation amount, based on a difference between a charging power amount and a discharging power amount of the battery 144. In contrast, the control device 162 according to a second embodiment updates the target power generation amount, based on running power and regenerative power of the transport vehicle 10. Therefore, the measurement device 161 according to the second embodiment measures consumed power and the regenerative power of the travel drive motor 156 instead of the charging power and the discharging power of the battery 144.

### <<Operation of Control Device 162>>

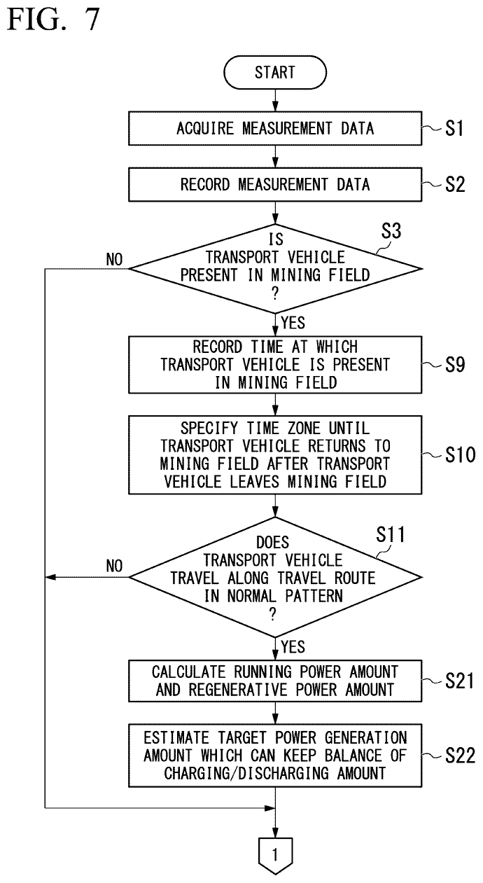

FIG. 7 is a flowchart representing a process in which control data is set by the control device 162 according to the second embodiment. The process of the control device 162 according to the second embodiment is different from the process in the first embodiment in that an operation of the power determination unit 175 is different. The power determination unit 175 according to the second embodiment performs processes in Step S21 and Step S22 below, instead of processes in Steps S12 to S16.

The power determination unit 175 calculates a running power amount and a regenerative power amount in the time zone, based on the time series of the measurement data in the time zone specified in Step S10 (Step S21). The power determination unit 175 estimates the target power generation amount that can keep balance of the charging/discharging amount of the battery 144, based on the running power amount and the regenerative power amount, and updates the target power generation amount (Step S22). For example, the power determination unit 175 may estimate the target power generation amount that can keep balance of the charging/discharging amount of the battery 144, based on a ratio between the running power amount and the regenerative power amount. In addition, for example, the power determination unit 175 may estimate the target power generation amount, based on power obtained by dividing a difference between the running power amount and the regenerative power amount by a travel time along the travel route.

### Another Embodiment

Although an embodiment has been described in detail above with reference to the drawings, the specific configurations are not limited to those which are described above, and various design changes can be made. That is, in another embodiment, the order of the above-described processes may be appropriately changed. In addition, some processes may be performed in parallel.

The control device 162 according to the embodiments described above may include a single computer, or the configuration of the control device 162 may be divided and disposed into a plurality of computers, and the plurality of computers may cooperate with each other to function as the control device 162. In this case, some computers forming the control device 162 may be mounted inside the transport vehicle 10, and the other computers may be provided outside a work machine (for example, a management device not represented).

The control device 162 according to the embodiment described above updates the target power generation amount, based on the measurement data while the transport vehicle 10 travels along the most recent travel route. However, the present disclosure is not limited thereto. For example, the control device 162 according to another embodiment may update the target power generation amount, based on statistical processing of the measurement data while the transport vehicle 10 travels along a plurality of the travel routes in the past. For example, the control device 162 may update the target power generation amount, based on an average of the measurement data while the transport vehicle 10 travels along the plurality of travel routes in the past. In this case, the control device 162 may update the target power generation amount, based on a group from which the outlier is excluded based on the standard deviation.

The transport vehicle 10 according to the embodiments described above is a manned vehicle operated by an operator. However, the present disclosure is not limited thereto. For example, the transport vehicle 10 according to another embodiment may be an unmanned vehicle that automatically travels. In this case, the control system 16 of the transport vehicle 10 may not include the operation device 163. In addition, the vehicle body control unit 176 may generate the control signal under PID control, based on the travel route and the measurement value of the measurement device 161.

In addition, the transport vehicle 10 has been described as an example of the work vehicle in the embodiments described above. However, the present disclosure is not limited thereto. For example, in another embodiment, the control device 162 may be mounted on other work vehicles such as a hydraulic excavator, a wheel loader, and a dump truck.

In addition, in the embodiment described above, in the transport vehicle 10, both the start point and the end point of the travel route are located in the mining field P1, and the travel route forms one cycle of the work cycle in the mine. However, the present disclosure is not limited thereto. For example, the travel route according to another embodiment may be a route in which the mining field PI is the start point and the earth disposal field P2 is the end point, or may be a route in which the earth disposal field P2 is the start point and the mining field P1 is the end point. In this case, the transport vehicle 10 determines the target power generation amount for each type of the travel routes. For example, the travel route according to another embodiment may determine the target power generation amount for each of the travel routes in which the mining field P1 is the start point and the earth disposal field P2 is the start point, and may switch between the target power generation amounts in accordance with the travel route along which the transport vehicle 10 travels.

In addition, in the embodiment described above, the measurement device 161 measures the power relating to the transport vehicle 10, but the present disclosure is not limited thereto. The measurement device 161 according to another embodiment may obtain a measurement value relating to the power. For example, the measurement device 161 according to another embodiment may measure a voltage, a current, or a resistance value.

### Configuration of Computer

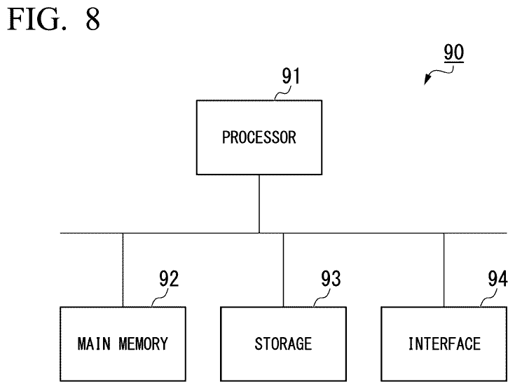

FIG. 8 is a schematic block diagram representing a configuration of a computer according to at least one embodiment.

A computer 90 includes a processor 91, a main memory 93, a storage 95, and an interface 97.

The control device 162 described above is mounted on the computer 90. In addition, an operation of each processing unit described above is stored in the storage 95 in a form of a program. The processor 91 reads out the program from the storage 95, develops the program on the main memory 93, and executes the processing described above in accordance with the program. In addition, the processor 91 secures a storage region corresponding to each storage unit described above in the main memory 93 in accordance with the program. Examples of the processor 91 include a central processing unit (CPU), a graphic processing unit (GPU), and a microprocessor.

The program may partially realize functions fulfilled by the computer 90. For example, the program may fulfill a function in combination with another program previously stored in the storage or in combination with another program installed in another device. In another embodiment, the computer 90 may include a custom large scale Integrated circuit (LSI) such as a programmable logic device (PLD) in addition to the configuration or instead of the configuration. Examples of the PLD include a programmable array logic (PAL), a generic array logic (GAL), a complex programmable logic device (CPLD), and a field programmable gate array (FPGA). In this case, some or all of the functions realized by the processor 91 may be realized by the integrated circuit. This integrated circuit is also included as an example of the processor.

Examples of the storage 95 include a magnetic disk, a magneto-optical disk, an optical disk, and a semiconductor memory. The storage 95 may be an internal medium directly connected to a bus of the computer 90, or may be an external medium connected to the computer 90 via the interface 97 or a communication line. In addition, when the program is distributed to the computer 90 via the communication line, the computer 90 receiving the distribution may develop the program on the main memory 93, and execute the processing described above. In at least one embodiment, the storage 95 is a non-transitory tangible storage medium.

In addition, the program may partially realize the above-described function. Furthermore, the program may be a so-called differential file (differential program) that realizes the functions described above in combination with other programs previously stored in the storage 95.

### Industrial Applicability

According to the above-described aspect, the control system can appropriately distribute energy of the fuel cell and the battery.

### REFERENCE SIGNS LIST

1: Transport system
10: Transport vehicle
11: Dump body
12: Vehicle body
13: Travel device
14: Power system
141: Hydrogen tank
142: Hydrogen supply device
143: Fuel cell
144: Battery
145: DCDC converter
146: Retarder grid
15: Drive system
151: Inverter
152: Pump drive motor
153: Hydraulic pump
154: Hoist cylinder
155: Inverter
156: Travel drive motor
16: Control system
161: Measurement device
162: Control device
163: Operation device
171: Storage unit
172: Data acquisition unit
173: Time zone specification unit
174: Pattern determination unit
175: Power determination unit
176: Vehicle body control unit
177: Fuel cell control unit
178: Required power calculation unit
179: Battery control unit
30: Loading machine
90: Computer
91: Processor
93: Main memory
95: Storage
97: Interface
B: Bus
C: Course
P1: Mining field
P2: Earth disposal field

1. A control system configured to control a work vehicle including a fuel cell and a battery, the control system comprising:
a power determination unit configured to determine a target power generation amount of the fuel cell, based on a time series of measurement values relating to power while the work vehicle travels along a predetermined travel route;
a fuel cell control unit configured to control the fuel cell to output the target power generation amount while the work vehicle travels along the travel route; and
a battery control unit configured to control charging or discharging of the battery, based on a difference between required power required for driving the work vehicle and the target power generation amount while the work vehicle travels along the travel route.

2. The control system according to claim 1, further comprising:
a time zone specification unit configured to specify a time zone in which the work vehicle travels along the travel route by specifying a timing at which the work vehicle exists at a specification point on the travel route, based on measurement data of the work vehicle,
wherein the power determination unit determines the target power generation amount, based on the time series of the measurement values of the power in the specified time zone.

3. The control system according to claim 2,
wherein the travel route is a route in which the specification point is a start point and an end point, and
the time zone specification unit specifies the timing at which the work vehicle is located at the specification point to specify the time zone between two consecutive timings in a plurality of the specified timings as the time zone in which the work vehicle travels along the travel route.

4. The control system according to claim 3, further comprising:
a pattern determination unit configured to determine whether or not the work vehicle travels along the travel route in a normal pattern in the time zone specified by the time zone specification unit,
wherein the power determination unit determines the target power generation amount, based on the time series of the measurement values of the power in the time zone in which it is determined that the work vehicle travels along the travel route in the normal pattern.

5. The control system according to claim 1,
wherein the power determination unit determines a constant value of the target power generation amount while the work vehicle travels along the travel route.

6. The control system according to claim 1,
wherein the power determination unit determines the target power generation amount of the fuel cell, based on the time series of the measurement values relating to the power for each of a plurality of times of travelling of the work vehicle on the travel route.

7. The control system according to claim 1,
wherein the power determination unit determines the target power generation amount of the fuel cell, based on the time series of the measurement values relating to charging power and discharging power while the work vehicle travels along the predetermined travel route.

8. The control system according to claim 1,
wherein the power determination unit determines the target power generation amount of the fuel cell, based on the time series of the measurement values relating to running power and regenerative power while the work vehicle travels along the predetermined travel route.

9. A work vehicle comprising:
a fuel cell;
a battery; and
the control system according to claim 1.

10. A control method for a work vehicle including a fuel cell and a battery, the method comprising:
a step of determining a target power generation amount of the fuel cell, based on a time series of measurement values relating to power while the work vehicle travels along a predetermined travel route;
a step of controlling the fuel cell to output the target power generation amount while the work vehicle travels along the travel route; and
a step of controlling charging or discharging of the battery, based on a difference between required power required for driving the work vehicle and the target power generation amount while the work vehicle travels along the travel route.

11. The control system according to claim 2,
wherein the power determination unit determines a constant value of the target power generation amount while the work vehicle travels along the travel route.

12. The control system according to claim 3,
wherein the power determination unit determines a constant value of the target power generation amount while the work vehicle travels along the travel route.

13. The control system according to claim 2,
wherein the power determination unit determines the target power generation amount of the fuel cell, based on the time series of the measurement values relating to the power for each of a plurality of times of travelling of the work vehicle on the travel route.

14. The control system according to claim 3,
wherein the power determination unit determines the target power generation amount of the fuel cell, based on the time series of the measurement values relating to the power for each of a plurality of times of travelling of the work vehicle on the travel route.

15. The control system according to claim 2,
wherein the power determination unit determines the target power generation amount of the fuel cell, based on the time series of the measurement values relating to charging power and discharging power while the work vehicle travels along the predetermined travel route.

16. The control system according to claim 3,
wherein the power determination unit determines the target power generation amount of the fuel cell, based on the time series of the measurement values relating to charging power and discharging power while the work vehicle travels along the predetermined travel route.

17. The control system according to claim 2,
wherein the power determination unit determines the target power generation amount of the fuel cell, based on the time series of the measurement values relating to running power and regenerative power while the work vehicle travels along the predetermined travel route.

18. The control system according to claim 3,
wherein the power determination unit determines the target power generation amount of the fuel cell, based on the time series of the measurement values relating to running power and regenerative power while the work vehicle travels along the predetermined travel route.

19. A work vehicle comprising:
a fuel cell;
a battery; and
the control system according to claim 2.

20. A work vehicle comprising:
a fuel cell;
a battery; and
the control system according to claim 3.
